(19) United States
(12) Patent Application Publication
(10) Pub. No.: US 2026/0366699 A1
(43) Pub. Date: Nov. 19, 2026

(54) BUTTON BACKLIGHTING FOR A LOAD CONTROL DEVICE

(71) Applicant: Crestron Electronics, Inc., Rockleigh, NJ (US)

(72) Inventors: Agnieszka Libson, Upper Saddle River, NJ (US); Dennis J. Hromin, Park Ridge, NJ (US)

(73) Assignee: Crestron Electronics, Inc., Rockleigh, NJ (US)

(21) Appl. No.: 19/303,534

(22) Filed: Aug. 19, 2025

Related U.S. Application Data
(60) Provisional application No. 63/804,826, filed on May 13, 2025.

(51) Int. Cl. F21V 7/00; F21V 23/04; F21Y 103/10; F21Y 115/10

(52) U.S. Cl. CPC F21V 7/005; F21V 23/04; F21Y 2103/10; F21Y 2115/10

(57) ABSTRACT

A control device for backlighting the buttons of a load control device in a cost effective and efficient manner while achieving substantially even light distribution and enhanced backlighting effects. The control device comprises a front housing portion having a light bar and an LED positioned to direct light into a side of the light bar. The light bar may comprise a second side disposed at an acute angle with respect to its rear surface to capture light and increase light intensity proximate to the second side of the light bar. The rear surface of the light bar may further comprise a diffusion gradient adapted to substantially evenly distribute light between its first and the second sides. The button comprises a first backlit area positioned over the light bar to be backlit by the LED.

### BACKGROUND OF THE INVENTION

### Technical Field

Aspects of the embodiments relate to load control devices, and more specifically to an apparatus, system and method for backlighting the buttons of a load control device in a cost effective and efficient manner while achieving substantially even light distribution and enhanced backlighting effects.

### Background Art

The popularity of home and building automation has grown in recent years partially due to increases in affordability, improvements, simplicity, and a higher level of technical sophistication of the average end-user. Automation systems integrate various electrical and mechanical system elements within a building or a space, such as a residential home, commercial building, hotels, or individual rooms, including meeting rooms, lecture halls, or the like. Examples of such system elements include lighting control systems, heating, ventilation and air conditioning (HVAC), audio and video (AV) switching and distribution, motorized window treatments (including blinds, shades, drapes, curtains, etc.), occupancy and/or lighting sensors, and/or motorized or hydraulic actuators, and security systems, to name a few.

One way a user can be given control of an automation system is through the use of one or more load control devices, such as keypads. A keypad is typically mounted in a recessed receptacle in a building wall, commonly known as an electrical or a gang box, and comprises one or more buttons or keys each assigned to perform a predetermined or assigned function. Assigned functions may include turning various types of loads on or off, or sending other types of commands to the loads, for example, orchestrating various lighting presets or scenes of a lighting load.

The various buttons are typically removable and may be printed with indicia to either identify their respective function or indicate status of the controlled load. These buttons may include backlighting via light emitting diodes (LEDs), giving the customer the ability to change backlight color of these buttons to any desired color as an added feature. For example, different button backlight colors may be used to distinguish between buttons, load types (e.g., emergency load), or the load state (e.g., on or off), or button backlight colors may be chosen to complement the surroundings or to give a pleasing visual effect.

To backlight an entire span of the indicia printed on a button, typically a plurality of LED's are used to achieve even light distribution along the horizontal surface of the button. To add additional indication to a button, besides backlighting the indicia, additional LED's are required. As is apparent, such configurations can become costly as they require additional components. Moreover, as the number and size of the components increase, so is the size of the control device and the size of its buttons, which is undesirable as it impedes the aesthetic look of a control device. The size, the number, and configuration of the components must be taken into account to achieve a compact, clean, and minimalistic appearance, while providing enhanced backlighting functionality and features.

Accordingly, a need has arisen for an apparatus, system, and method for backlighting the buttons of a load control device in a cost effective and efficient manner while achieving substantially even light distribution and enhanced backlighting effects.

### SUMMARY OF THE INVENTION

It is an object of the embodiments to substantially solve at least the problems and/or disadvantages discussed above, and to provide at least one or more of the advantages described below.

It is therefore a general aspect of the embodiments to provide an apparatus, system, and method for backlighting the buttons of a load control device in a cost effective and efficient manner while achieving substantially even light distribution and enhanced backlighting effects.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Further features and advantages of the aspects of the embodiments, as well as the structure and operation of the various embodiments, are described in detail below with reference to the accompanying drawings. It is noted that the aspects of the embodiments are not limited to the specific embodiments described herein. Such embodiments are presented herein for illustrative purposes only. Additional embodiments will be apparent to persons skilled in the relevant art(s) based on the teachings contained herein.

### Disclosure of Invention

According to one aspect of the embodiments, a control device is provided for controlling an associated electrical load. The control device comprises a front housing portion comprising a switch, a first LED, and a longitudinal light bar having a front surface and a rear surface extending between a first side and a second side, wherein the first LED is positioned to direct light into the first side of the light bar. The control device further comprises a controller electrically connected to the switch to send a control signal to the associated electrical load in response to an actuation of the switch and a button comprising a front surface and a rear surface extending between a first side and a second side, wherein the button attaches to the front housing portion and is adapted to actuate the switch, wherein the button comprises an opaque material and a first backlit area formed therethrough comprising translucent material, wherein the first backlit area is positioned over the front surface of the light bar and is backlit by the first LED. The rear surface of the light bar comprises a diffusion gradient comprising a plurality of areas of reflection to facilitate light distribution between the first side of the light bar and the second side of the light bar.

According to an embodiment, the diffusion gradient comprises a plurality of areas of reflection that gradually increase in size and/or frequency from the first side of the light bar to the second side of the light bar. According to another embodiment, the diffusion gradient comprises a pattern of a plurality of areas of reflection that gradually change from thinner and less frequent areas of reflection proximate the first side of the light bar to thicker and more frequent areas of reflection proximate the second side of the light bar. The gradient may further comprise a first area of reflection disposed between the first side of the light bar and the pattern, wherein the first area of reflection is larger than any one of the plurality of areas of reflection in the pattern to capture light from the first LED and increase light intensity. According to an embodiment, the second side of the light bar is disposed at an acute angle with respect to the rear surface of the light bar to capture light and increase light intensity proximate to the second side of the light bar, wherein the diffusion gradient further comprises a second area of reflection disposed beneath the angled second side of the light bar that changes to thinner and less frequent areas of reflection in comparison to the pattern proximate the second side of the light bar. According to a further embodiment, the diffusion gradient comprises a pattern having a first thinner areas of reflection that alternate between a second thicker areas of reflection, wherein the first thinner areas of reflection and the second thicker areas of reflection gradually get thicker and less spaced apart from the first side of the light bar to the second side of the light bar. According to yet another embodiment, the diffusion gradient comprises the light bar gradually changing in color from being a first color proximate to the first side of the light bar that diffuses less light, to being a second color proximate to the second side of the light bar that diffuses more light.

According to an embodiment, the second side of the light bar is disposed at an acute angle with respect to the rear surface of the light bar to capture light and increase light intensity proximate to the second side of the light bar. The angle may comprise an incident angle of a material of the light bar. According to another embodiment, the first side of the light bar comprises a taper that tapers inwardly from the front surface of the light bar to the rear surface of the light bar to capture light from the first LED.

According to an embodiment, the front housing portion comprises a cavity formed by lateral periphery walls that surround the light bar and the first LED. The front housing portion may comprise opaque material to hinder light transmission through the lateral periphery walls, wherein an inner surface of the lateral periphery walls comprise light reflective material. At least one of the lateral periphery walls may further comprise a hood that encloses the first LED between the at least one of the lateral periphery walls and the first side of the light bar such that light from the first LED is directed to the first side of the light bar. According to an embodiment, the button comprises a second backlit area formed therethrough comprising translucent material, wherein the front housing portion further comprises a second LED positioned within the cavity, wherein the cavity comprises a separation wall that separates the first LED and the light bar from the second LED, wherein the second backlit area is positioned over and is backlit by the second LED. According to a further embodiment, the button comprises a divider made of an opaque material recessed in the rear surface and below the front surface of the button such that the divider is not perceived from the front surface, wherein the divider is positioned adjacent the separation wall to hinder light transmission between the first backlit area and the second backlit area. The divider may comprise a fin rearwardly extending from the rear surface of the button, wherein the fin partially overlaps and disposed adjacent to the separation wall to hinder light transmission between the first LED and the second LED.

According to yet another embodiment, the button comprises a depression recessed in the rear surface of the button, wherein the first backlit area is at least partially formed at the depression, wherein the button at the depression comprises a thickness that is thicker proximate the first side of the button to allow less light transmission through the first backlit area and gradually thinner proximate to the second side of the button to allow for gradually greater light transmission through the first backlit area.

According to another aspect of the embodiments, a control device is provided for controlling an associated electrical load. The control device comprises a front housing portion comprising a switch, a first LED, a second LED, and a longitudinal light bar having a front surface and a rear surface extending between a first side and a second side, wherein the first LED is positioned to direct light into the first side of the light bar. The control device further comprises a controller electrically connected to the switch to send a control signal to the associated electrical load in response to an actuation of the switch, and a button comprising a front surface and a rear surface extending between a first side and a second side, wherein the button attaches to the front housing portion and is adapted to actuate the switch, wherein the button comprises an opaque material and first and second backlit areas formed therethrough comprising translucent material, wherein the first backlit area is positioned over the front surface of the light bar and is backlit by the first LED, and wherein the second backlit area is positioned over and backlit by the second LED. The front housing portion comprises a cavity formed by lateral periphery walls that surround the light bar, the first LED, and the second LED, wherein the cavity comprises a separation wall that separates the first LED and the light bar from the second LED, and wherein the button comprises a divider made of an opaque material recessed in the rear surface and below the front surface of the button such that the divider is not perceived from the front surface, wherein the divider is positioned adjacent the separation wall to hinder light transmission between the first backlit area and the second backlit area. According to an embodiment, the front housing portion comprises opaque material to hinder light transmission through the lateral periphery walls, wherein an inner surface of the lateral periphery walls comprise light reflective material. According to another embodiment, the divider comprises a fin rearwardly extending from the rear surface of the button, wherein the fin partially overlaps and disposed adjacent to the separation wall to hinder light transmission between the first LED and the second LED.

### BRIEF DESCRIPTION OF THE DRAWINGS

The above and other objects and features of the embodiments will become apparent and more readily appreciated from the following description of the embodiments with reference to the following figures. Different aspects of the embodiments are illustrated in reference figures of the drawings. It is intended that the embodiments and figures disclosed herein are to be considered to be illustrative rather than limiting. The components in the drawings are not necessarily drawn to scale, emphasis instead being placed upon clearly illustrating the principles of the aspects of the embodiments. In the drawings, like reference numerals designate corresponding parts throughout the several views.

### Brief Description of the Several Views of the Drawings

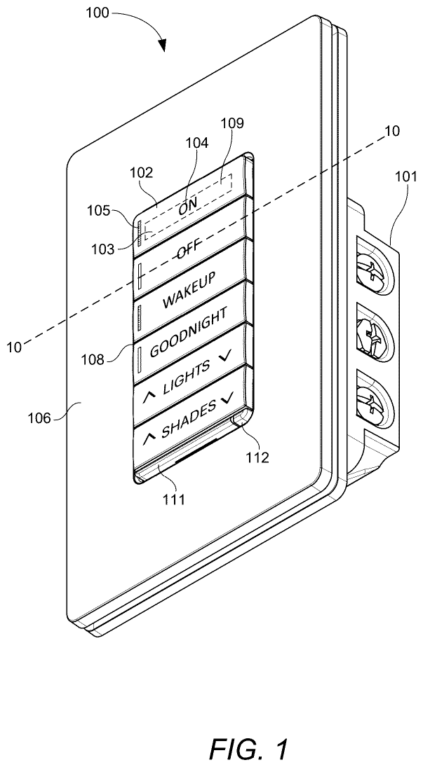

FIG. 1 illustrates a perspective front view of an illustrative load control device according to an illustrative embodiment.

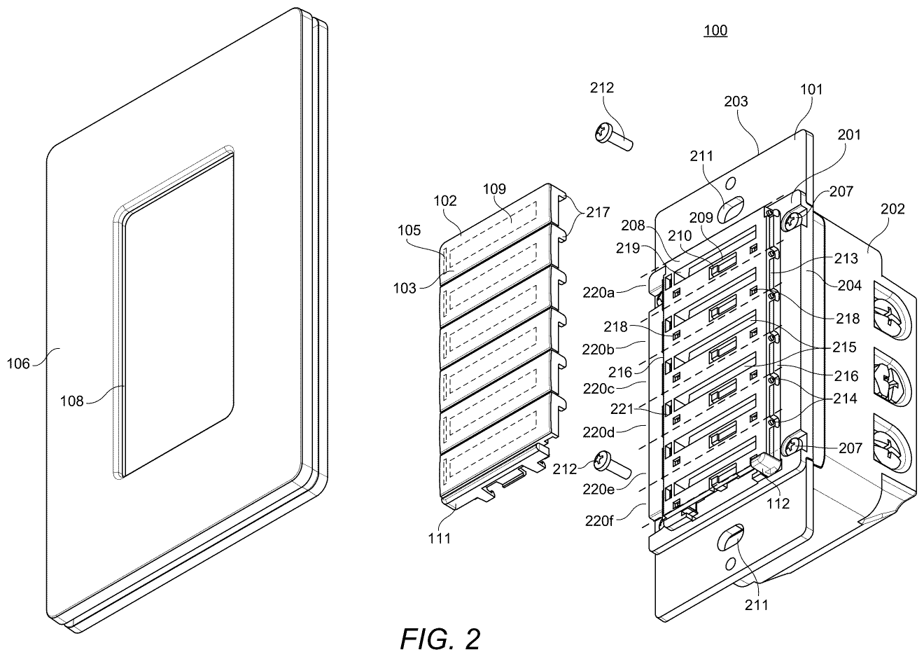

FIG. 2 illustrates a perspective front view of the load control device with the faceplate and buttons removed according to an illustrative embodiment.

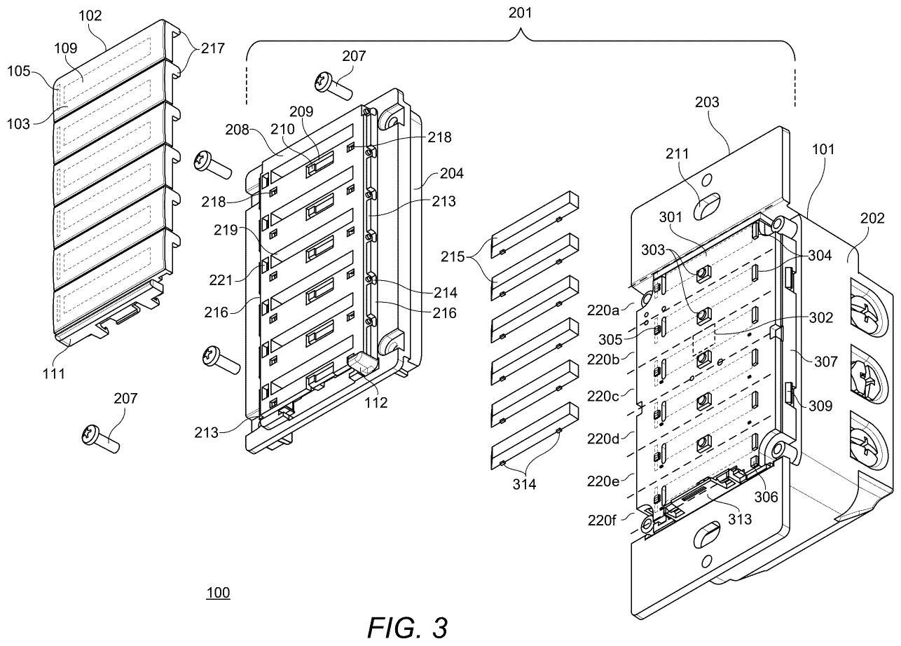

FIG. 3 illustrates a partially exploded perspective front view of the load control device according to an illustrative embodiment.

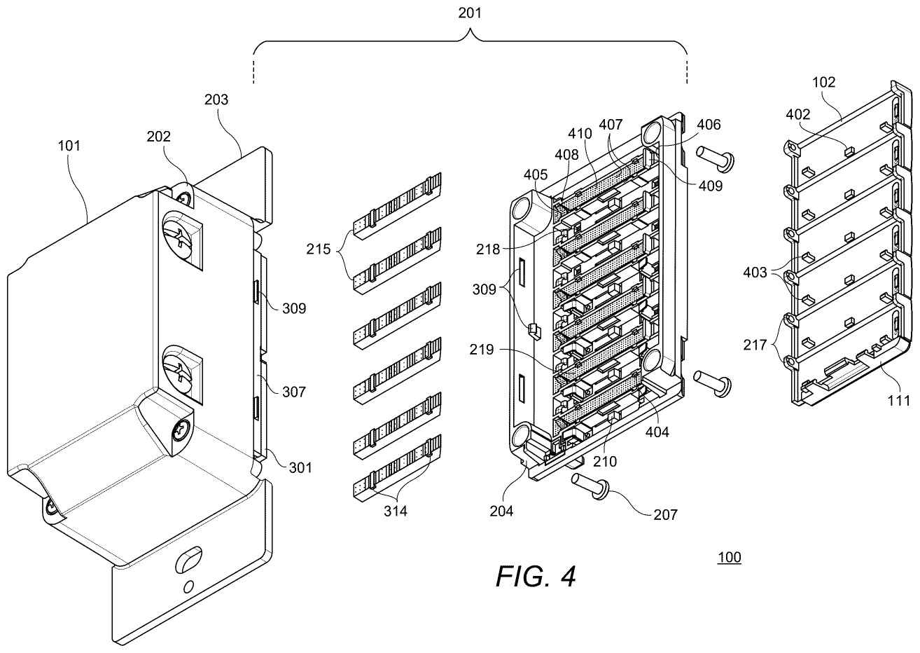

FIG. 4 illustrates a partially exploded perspective rear view of the load control device according to an illustrative embodiment.

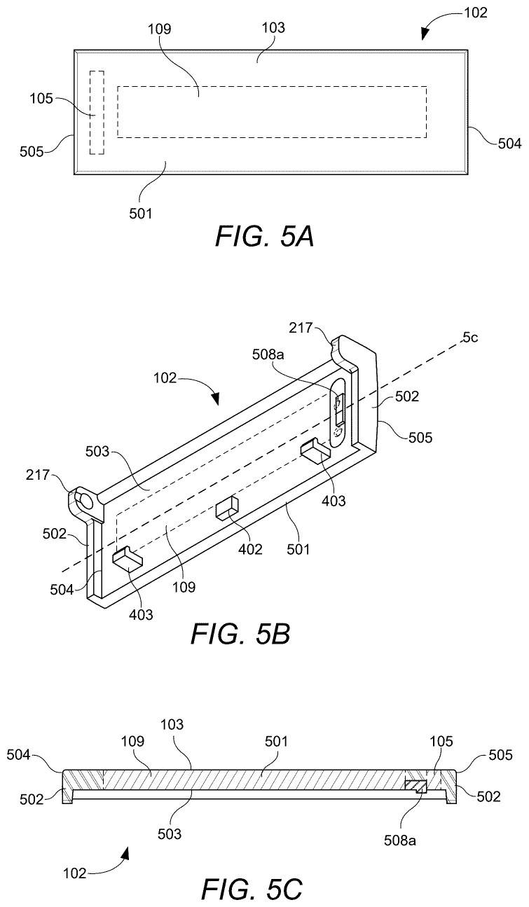

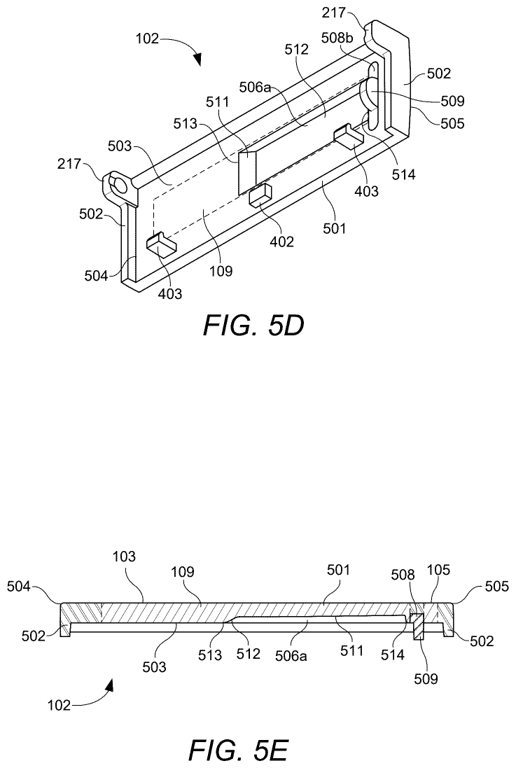

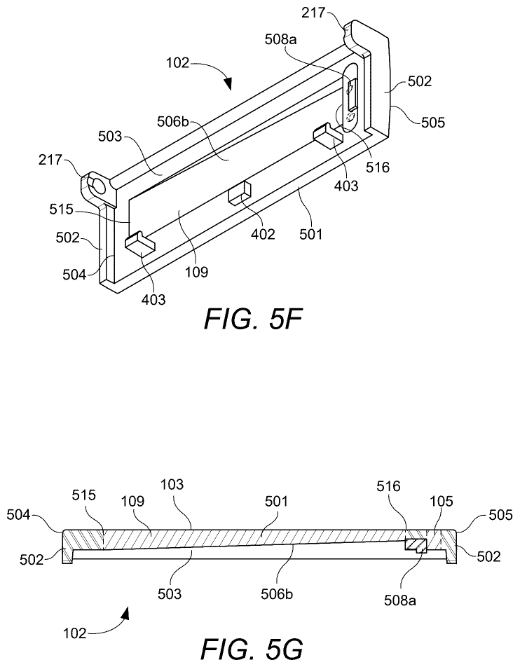

FIG. 5A illustrates a front view of the button of the load control device according to an illustrative embodiment.

FIG. 5B illustrates a rear perspective view of a button of the load control device according to an illustrative embodiment.

FIG. 5C illustrates a top cross sectional view of the button of the load control device according to an illustrative embodiment.

FIG. 5D illustrates a rear perspective view of a button of the load control device according to another illustrative embodiment.

FIG. 5E illustrates a top cross sectional view of the button of the load control device according to another illustrative embodiment.

FIG. 5F illustrates a rear perspective view of a button of the load control device according to yet another illustrative embodiment.

FIG. 5G illustrates a top cross sectional view of the button of the load control device according to yet another illustrative embodiment.

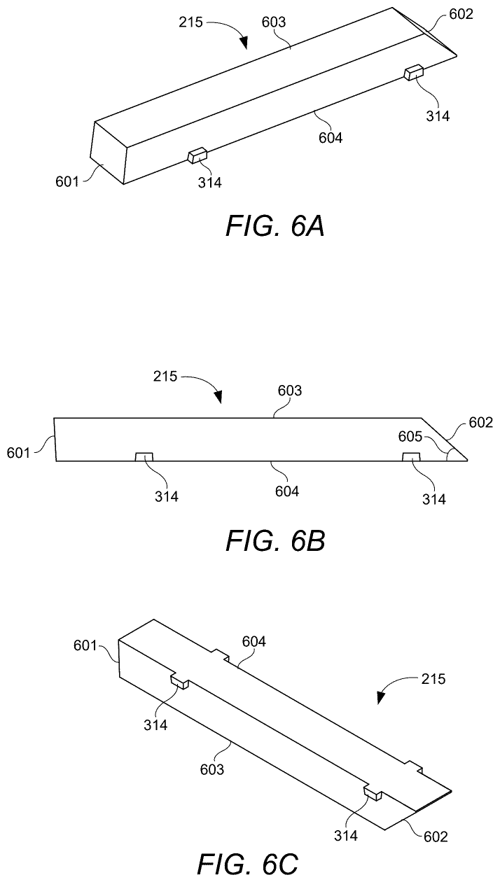

FIG. 6A illustrates a front perspective view of a light pipe of the load control device according to an illustrative embodiment.

FIG. 6B illustrates a side view of the light pipe of the load control device according to an illustrative embodiment.

FIG. 6C illustrates a rear perspective view of a light pipe of the load control device according to an illustrative embodiment.

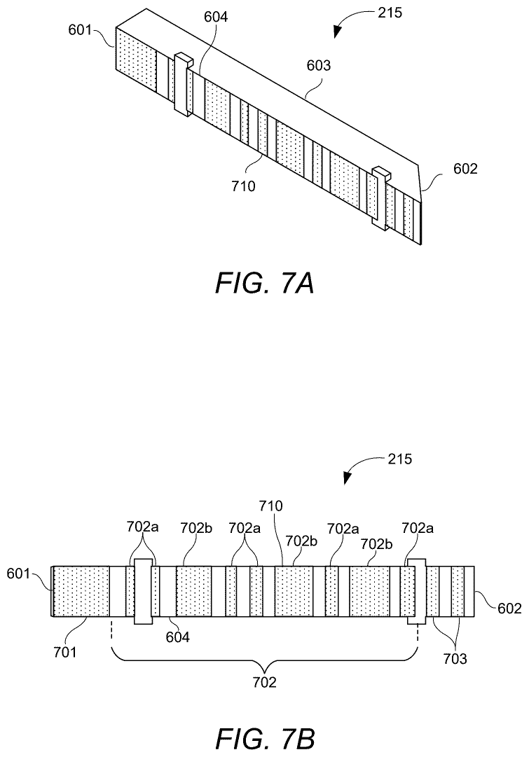

FIG. 7A illustrates a rear perspective view of a diffusion gradient of the light pipe according to an illustrative embodiment.

FIG. 7B illustrates a rear view of the diffusion gradient of the light pipe according to an illustrative embodiment.

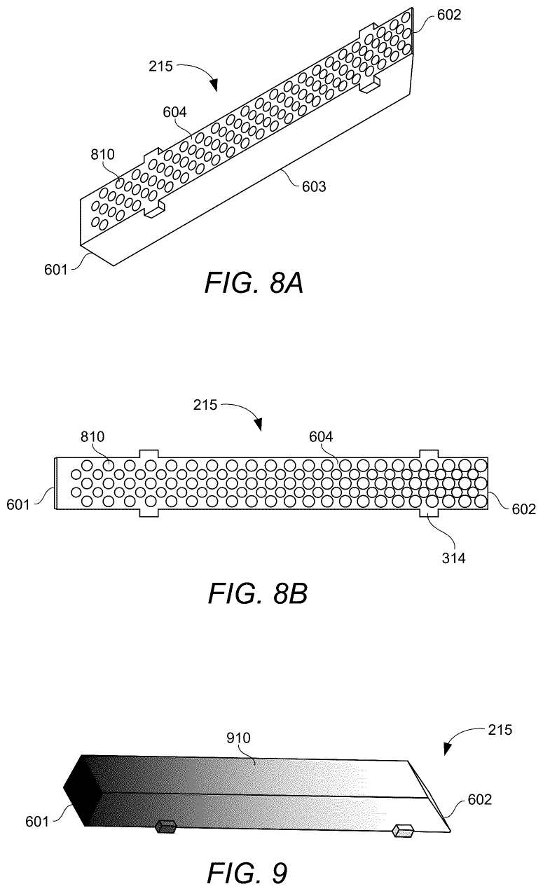

FIG. 8A illustrates a rear perspective view of a diffusion gradient of the light pipe according to another illustrative embodiment.

FIG. 8B illustrates a rear view of the diffusion gradient of the light pipe according to another illustrative embodiment.

FIG. 9 illustrates a front perspective view of the diffusion gradient of the light pipe according to yet another illustrative embodiment.

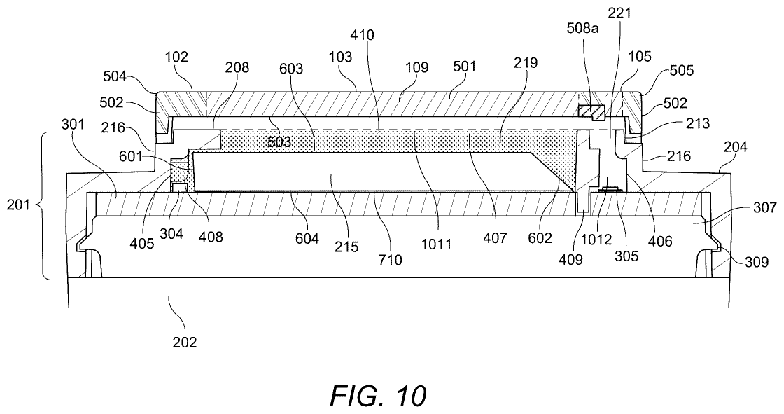

FIG. 10 illustrates a partial top cross sectional view of the load control device according to an illustrative embodiment.

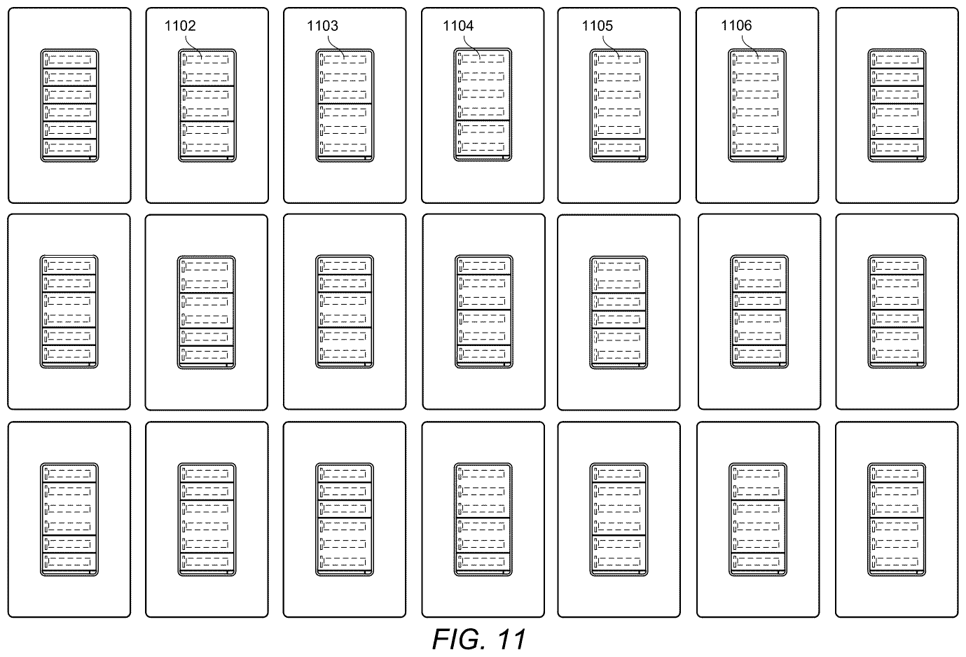

FIG. 11 illustrates examples of various possible button configurations of the load control device according to an illustrative embodiment.

### DETAILED DESCRIPTION OF THE INVENTION

The embodiments are described more fully hereinafter with reference to the accompanying drawings, in which embodiments of the inventive concept are shown. In the drawings, the size and relative sizes of layers and regions may be exaggerated for clarity. Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the inventive concept to those skilled in the art. The scope of the embodiments is therefore defined by the appended claims. The detailed description that follows is written from the point of view of a control systems company, so it is to be understood that generally the concepts discussed herein are applicable to various subsystems and not limited to only a particular controlled device or class of devices.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### LIST OF REFERENCE NUMBERS FOR THE ELEMENTS IN THE DRAWINGS IN NUMERICAL ORDER

The following is a list of the major elements in the drawings in numerical order.
10 Cross Section Line
100 Control Device
101 Housing
102 Button(s)
103 Front Surface
104 Indicia
105 Status Indicator(s)
106 Faceplate
108 Opening
109 Backlight/Indicia Area(s)
111 Airgap Pull
112 Sensor Light Pipe
201 Frontend Housing Portion
202 Backend Housing Portion
203 Yoke
204 Front cover portion
207 Screw(s)
208 Front Wall
209 Opening(s)
210 Switch Actuator(s)
211 Mounting Hole(s)
212 Screw(s)
213 Longitudinal Recessed Notch(es)
214 Tab Receiver(s)
215 Lights Pipe(s)/Light Bar(s)
216 Side Edge(s)
217 Tab(s)
218 Orifice(s)
219 Light Bar Opening(s)
220a-f Button Zones
221 Indicator Light Opening)s)
301 Printed Circuit Board (PCB)
302 Controller
303 Tactile Switch(es)
304 Backlight Light Source(s)
305 Indicator Light Source(s)
306 Light Sensor
307 Rear cover portion
309 Snap-Fit Connector(s)
313 Airgap Actuator
314 Feet
402 Projection(s)
403 Arm(s)
404 Notch(es)
405 First Side Wall
406 Second Side Wall
407 Lateral Wall(s)
408 Hood
409 Separation Wall(s)
410 Reflective Surface
501 Front Wall
502 Side Wall(s)
503 Rear Surface
504 First Side
505 Second Side
506a Depression
506ab Depression
508a Divider
508b Divider
509 Fin
511 First Portion
512 Second Portion
513 First End
514 Second End
515 First End
516 Second End
5c Cross Section Line
601 First Side
602 Second Side
603 Front Surface
604 Rear Surface
605 Angle
701 First Area of Reflection
702 Diffusion Gradient Pattern
702a First Thinner Areas of Reflection/White Lines
702b Second Thicker Areas of Reflection/White Lines p1 703 Second Area of Reflection
710 Diffusion Gradient
810 Diffusion Gradient
910 Diffusion Gradient
1011 First Enclosure
1012 Second Enclosure
1102 Two-Zone Height Button
1103 Three-Zone Height Button
1104 Four-Zone Height Button
1105 Five-Zone Height Button
1106 Six-Zone Height Button

### LIST OF ACRONYMS USED IN THE SPECIFICATION IN ALPHABETICAL ORDER

The following is a list of the acronyms used in the specification in alphabetical order.
AC Alternating Current
ASIC Application Specific Integrated Circuit
AV Audiovisual
DC Direct Current
HVAC Heating, Ventilation and Air Conditioning
K Kelvin
IR Infrared
LED Light Emitting Diode
NFC Near-Field Communication
PCB Printed Circuit Board
PoE Power-over-Ethernet
PWM Pulse Width Modulation
RAM Random-Access Memory
RF Radio Frequency
RGB Red-Green-Blue
RISC Reduced Instruction Set Computer
ROM Read-Only Memory

### MODE(S) FOR CARRYING OUT THE INVENTION

The different aspects of the embodiments described herein pertain to the context of load control devices, but are not limited thereto, except as may be set forth expressly in the appended claims. Particularly, the aspects of the embodiments are related to an apparatus, system, and method for backlighting the buttons of a load control device in a cost effective and efficient manner while achieving substantially even light distribution and enhanced backlighting effects.

Referring to FIG. 1, there is shows a perspective front view of an illustrative load control device 100 according to an illustrative embodiment. Control device 100 may serve as a user interface to associated loads or load controllers in a space. In various aspects of the embodiments, control device 100 may control various types of electrical devices or loads, including, but not limited to audiovisual (AV) equipment, lighting, shades, screens, computers, laptops, heating, ventilation and air conditioning (HVAC), security, appliances, and other devices in a space or building. Control device 100 may be used in residential load control, or in commercial settings, such as in hospitality settings, classrooms, meeting rooms, or the like.

Control device 100 may be configured to be mounted on the wall inside an electrical box, or other surfaces as discussed below. According to an embodiment, control device 100 may be configured as a keypad comprising a plurality of buttons. For example, as shown in FIG. 1, control device 100 may comprise six single height buttons 102, some of which can be push buttons and others rocker buttons, as required for the desired application. Although other button sizes, types, and configurations may be used as further described below. Each button 102 may be associated with a particular load and/or a particular operation of a load. For example, different buttons 102 may correspond to different lighting scenes of lighting loads, such as certain combination of lighting loads in a room and/or settings to create different lighting scenes. As described below, control device 100 may be configured as a lighting switch where the buttons 102 may be used to control an on/off status of a load, and/or a dimmer where one or more of the buttons 102 can be used to control a dimming setting of a load.

In an illustrative embodiment, control device 100 may be configured to receive control commands directly from a user via buttons 102 and control an operation of an associated load (such as a light, fan, window blinds, etc.) based on the control commands. Control device 100 may in addition, or alternatively, control a load indirectly by transmitting control commands to another control device, a central control processor, a load controller (e.g., LED driver) electrically connected the load, and/or another electrical device to control an operation of the load based on the control commands. Control device 100 may also be configured to receive control commands from another control device, a central control processor, a user communication device, or other electrical device, and in response control an associated load.

One or more of the buttons 102 may comprise indicia 104 disposed thereon to provide designation of the button's function, such as in the form of letters, numbers, symbols (e.g., light bulb, fan, up, down, left, and/or right errors, etc.), or the like, or any combinations thereof. Indicia 104 may be formed anywhere within the allowable indicia area 109. Indicia 104 may be backlit by a light source, such as light emitting diodes (LEDs), or other types of light sources now known or later discovered. According to another embodiment, the entire or substantially the entire button 102 may be backlit, and/or the button 102 may not comprise any indicia 104. LEDs may comprise single color LEDs, or LEDs that can vary in color, color temperature, and/or intensity (i.e., dimmable LEDs). LEDs may be configured to turn on and off, and/or change in color, color temperature, intensities, lighting patterns (e.g., blinking), and/or other lighting effects for visibility or visual effects, and/or to provide status indication and/or color coding for the button's function. For example, different buttons 102 may be backlit via different colors to distinguish between buttons, load types (e.g., emergency load), load states (e.g., on, off, and/or selected scene), AV state (e.g., selected station or selected channel), or the like. Button backlight colors may also be chosen to complement the surroundings or to give a pleasing visual effect.

One or more of the buttons 102 may further comprise a status indicator 105, for example in a form of a vertical bar, although other shapes can be utilized such as a horizontal bar, a circle, a square, a symbol, or the like. According to the present embodiments, status indicator 105 may also be backlit, for example via another set of LEDs, which may be turned on and off, and/or change in color, color temperature, intensities, lighting patterns, and/or other lighting effects as discussed above. Status indicators 105 may be used to indicate various status states, such as the state of the button and/or the connected load (e.g., on or off), status of the battery of the control device 100, set up statuses (e.g., status of network connection), or the like. According to another embodiment, a plurality of status indicators 105 may cooperate to form a bar graph, for example to indicate a dimming level of the load. According to the present embodiments, the indicia backlighting and status indicator of each button 102 can be individually controlled at different settings.

According to an embodiment, buttons 102 may comprise opaque material or layer while the indicia 104 and light indicators 105 may be transparent or translucent allowing light from the LEDs to pass through the indicia 104 and light indicators 105 and be perceived from the front surface 103 of the button 102. Indicia 104 and/or indicators 105 may be formed by engraving, tinting, printing, applying a film, etching, and/or similar processes. For example, each button 102 may comprise a substantially transparent or translucent material. The front surface 103 of the button 102 may be coated using an opaque material, such as paint, film, tint, or the like. The indicia 104 and/or indicators 105 may then be engraved onto the button 102 exposing the transparent or translucent material. According to yet another embodiment, buttons 102 may comprise transparent or translucent material, while the indicia 104 and/or indicators 105 may comprise opaque material.

Reference is now made to FIGS. 1 and 2, where FIG. 2 shows the control device 100 with the faceplate 106 and buttons 102 removed. Control device 100 may comprise housing 101 adapted to house various electrical components of the control device 100. Housing 101 may be configured to carry the buttons 102 thereon. According to various embodiments, housing 101 may comprise a bezel frame that surrounds the buttons 102, or as shown in the present embodiments, control device 100 may be bezel free with buttons 102 sitting directly within the faceplate opening 108. Housing 101 may comprise mounting holes 211 for mounting the control device 100 to a standard electrical box via screws 212. According to another embodiment, control device 100 may be mounted flush mount on a wall or to other surfaces using an enclosure. According yet to another embodiment, control device 100 may be configured to sit freestanding on a surface, such as a table, via a table-top enclosure. Once mounted to a wall or an enclosure, housing 101 may be covered using a faceplate 106. Faceplate 106 may comprise an opening 108 sized and shaped for receiving the buttons 102 therein (or a bezel if one is used). Faceplate 106 may be secured to the housing 101 using screws (not shown), or via other types of connectors, such as snap-fit connectors. According to another embodiment, a plurality of control devices 100 may be mounted side-by-side in a multi gang electrical box and covered by a multi gang faceplate.

Further referring to FIG. 3-4, where FIG. 3 illustrates a partially exploded perspective front view of the load control device 100 and FIG. 4 illustrates a partially exploded perspective rear view of the load control device 100. Housing 101 of control device 100 may comprise a frontend housing portion 201 and a backend housing portion 202, although other housing configurations may be used without departing from the scope of the present embodiments. The backend housing portion 202 may fit within a standard electrical or junction box and may comprise a yoke 203 for attaching the control device 100 to the junction box as discussed above. The backend housing portion 202 may contain various electrical components for providing power and data communication to the various circuit components of the control device 100. These components may be disposed on and/or be connected to one or more printed circuit boards (PCBs) within the backend housing portion 202, and may include one or more communication interfaces, power terminals, communication network interfaces, and power supply components, such as power converters (e.g., AC to DC converters), power regulators, overvoltage, overcurrent, and/or overload protection, airgap switch, as well as other types of components known in the art. Control device 100 may be powered by an electric alternating current (AC) power signal from an AC mains power source and may convert the AC signal to direct current (DC) for powering the electrical components of the control device 100. Such control device 100 may comprise connectors, such as screws or push-in connectors, power terminals, or wire leads suitable for making line voltage connections. In another embodiment, the control device 100 may receive power from a direct current (DC) voltage power source. In yet another embodiment, the control device 100 may be powered using Power-over-Ethernet (PoE) and may comprise a PoE interface, such as via a Cresnet® port. However, other types of connections or ports may be utilized. According to another embodiment, or in addition, the power supply may comprise a replaceable or rechargeable battery for powering the control device 100. An airgap actuator 313 may be used to actuate an airgap switch within the housing backend portion 202 to disconnect power from the load. A decorative airgap pull 111 may be attached to the airgap actuator 313 right below the lowest most button 102 that can be pulled to by the user to actuate the airgap switch. Decorative airgap pull 111 may be of the same color as the buttons 102 and/or faceplate 106 to appear inconspicuous. Backend housing portion 202 may further comprise output power controlling components for controlling connected electrical loads, such as switching circuits, dimming circuits, relays, motor control modules, temperature control modules, or the like. Although some of the components discussed above may be disposed in the frontend housing portion 201.

The one or more of the communication interfaces may comprise one or more wired and/or wireless communication interfaces configured for transmitting and/or receiving messages over a communication network to and/or from various connected loads, other control devices, a central control processor, a user communication device, or other electrical device. Messages sent or received by the control device 100 via the communication network interface may comprise control commands, firmware updates, network formation, device discovery, and/or device commissioning information, feedback or status information, or the like, or any combinations thereof. A wired communication interface can comprise wire leads or a wired port and may be configured for bidirectional communication with other devices over a wired communication network. A wired communication network may be governed by standard and/or proprietary wired communication protocols, such as Cresnet®, DMX (e.g., DMX512), DALI®, 0-10V, RGBW, or other protocols known in the art. In various aspects of the embodiments, control device 100 can both receive and/or transmit electric power signals and control commands through a PoE interface. A wireless interface may be configured for bidirectional wireless communication with other electrical devices over a wireless communication network. In various embodiments, the wireless communication interface can comprise a radio frequency (RF) transceiver, an infrared (IR) transceiver, or other communication technologies known to those skilled in the art. The wireless communication network may be governed by standard and/or proprietary communication protocols, such as infiNET EX®, ZigBee®, Wi-Fi®, Z-Wave®, or other protocols known in the art. In yet another embodiment, the one or more communication interface can comprise a short range wireless interface to enable wireless communication with proximately located wireless devices, such as a user communication device (e.g., a smartphone, a tablet, a portable computer, or other portable electronic devices known in the art). Short range wireless interface may comprise an IR interface or a RF interface, such as a Bluetooth wireless interface, a near-field communication (NFC) interface, or other communications known in the art. According to another embodiment, the wireless communication interface may reside in the frontend housing portion 201.

The frontend housing portion 201 may comprises various mechanical and/or electrical components for providing a user interface and generating control commands. According to an embodiment, these electrical components may be low-voltage components disposed on a PCB 301 within the frontend housing portion 201. The frontend housing portion 201 may comprise a front cover portion 204 and a rear cover portion 307, which may be interconnected via one or more connectors, such as snap-fit connectors 309 (as shown in FIG. 10). The frontend housing portion 201 may in turn connect to the backend housing portion 202 via one or more connectors, such as screws 207. According to an embodiment, the electrical components of the frontend housing portion 201 (including the PCB 301) may electrically connect to the electrical components of the backend housing portion 202 via an electrical connector, such as a pogo-pin connector, although other connectors can be utilized.

The PCB 301 may include a controller 302 comprising and/or connected to one or more processors, memories, communication interfaces, or the like. The controller 302 may be disposed on the rear surface of the PCB 301. The processor of the controller 302 can comprise one or more microprocessors, “general purpose” microprocessors, a combination of general and special purpose microprocessors, application specific integrated circuits (ASIC), one or more reduced instruction set computer (RISC) processors, video processors, related chip sets, or the like, or any combinations thereof. The processor of the controller 302 can provide processing capability to execute an operating system, run various applications, and/or provide processing for one or more of the techniques and functions described herein. The memory of the controller 302 may be communicably coupled to the processor and can store data and executable code. The memory can represent volatile memory such as random-access memory (RAM), and/or nonvolatile memory, such as read-only memory (ROM) or Flash memory. In buffering or caching data related to operations of the processor, the memory can store data associated with applications running on the processor.

The front surface of the PCB 301 may comprise a plurality of micro-switches or tactile switches 303. For example, the PCB 301 may contain six vertically arranged tactile switches 303 to accommodate various number of button configurations as discussed below. However, other number of switches and layouts may be utilized to accommodate other button configurations. Each tactile switch 303 is adapted to be activated via a buttons 102 to receive user input. The PCB 301 may further comprise a plurality of touch sensors, such as capacitive touch sensors, to increate button configurations as further described in U.S. Pat. No. 11,640,216, issued on May 2, 2023, and titled “Wall Mounted Control Device with Tactile and Touch Sensing Button Combination to Increase Button Configuration”, the entire contents of which is hereby incorporated by reference. For example, a pair of touch sensors may be disposed on each side of the tactile switch 303 such that the button 102 may respond to a center press, a right press, and/or a left press, for example to enable a side to side rocker function. In another embodiment, the PCB 301 may comprise a plurality of tactile switches, such as three tactile switches 303, arranged in a row and capable of being activated by button 102 to respond to a center press, a right press, and/or a left press, as further described in U.S. Pat. No. 10,943,749, issued on Mar. 9, 2021, and titled “Wall Mounted Control Device with Interchangeable Buttons”, the entire contents of which is hereby incorporated by reference.

The control device 100 may further comprise a plurality of light sources 304 and 305 disposed on the front surface of the PCB 301 and adapted to emit one or a plurality of colors for providing backlighting and/or status indication to corresponding buttons 102. Each light source 304/305 may comprise a multicolored light emitting diode (LED), such as a red-green-blue LED (RGB LED), comprising of red, green, and blue LED emitters. Although the LED elements can comprise other color combinations of LED emitters, and/or can also comprise one or more white emitters. The plurality of LEDs 304/305 may be powered using one or more LED drivers located on PCB 301. According to an embodiment, each LED emitter of each LED 304/305 can be independently controlled at a different intensity using pulse width modulation (PWM) signal with a constant current LED driver having output values ranging between 0 and 65535 for a 16-bit channel—with 0 meaning fully off and 65535 meaning fully on. Varying these PWM values of each of the red, green, and blue LED emitters on each LED 304/305 allows the LED 304/305 to create any desired color within the device's color gamut, including any desired color temperature of white within a range of between about 1650 Kelvin (K) (warm colors) and about 8000K (cool colors), although other color temperature ranges may be achieved. According to an embodiment, LEDs 304 may be located on one side of the tactile switches 303 to backlight the button indicia 104 and LEDs 305 may be located on the opposite side of the tactile switches 303 to backlight the status indicator 105 as further discussed below. Apart of color, each LED 304/305 can be also controlled at a different light intensity and/or lighting patters. The present embodiments can also be implemented with LEDs capable of producing only a single or a limited number of colors. Furthermore, the present embodiments can be implemented with LEDs that can emit different color temperatures of white, such as tunable white LEDs, dim to warm LEDs, or LEDs with a plurality of predetermined color temperature settings. To vary color temperatures, the LEDs may comprise a plurality of white LEDs or white LED emitters with varying white color temperatures where mixing these LEDs can produce a desired color temperature.

The PCB 301 may further comprise a light sensor 306 configured for detecting and measuring ambient light. Light sensor 306 may be used to control the intensity levels of the light sources 304 and/or 305 and/or the associated lighting loads based on the measured ambient light. According to an embodiment, light sensor 306 may impact the intensity levels of the light sources 304 and/or 305 to stay at the same perceived level based on the measured ambient light levels. A light curve may be used to adjust the brightness of the light sources 304 and/or 305 based on measured ambient light levels by the light sensor 306. According to another embodiment, threshold values may be used. According to yet another embodiment, light sensor 306 may impact the color or an on/off state of the LEDs 304/305 based on the measured ambient light levels. According to yet another embodiment, where multi-colored light sources 304 and 305 are used, light sensor 306 may impact the color of the light sources 304 and/or 305 based on the measured ambient light levels. The front cover portion 204 may comprise a sensor light pipe 112 that may direct ambient light from the front surface of the control device 100 toward the light sensor 306. Sensor light pipe 112 may be positioned beneath the lowermost button 102 adjacent to the decorative airgap pull 111. According to an embodiment, the decorative airgap pull 111 and sensor light pipe 112 may be linearly arranged below and substantially aligned with the front surface of the keypad buttons 102—achieving a smooth, continuous, and inconspicuous appearance. According to further embodiments, the PCB 301 may comprise other types of sensors, such as motion, proximity, temperature, sound, and/or other sensors known in the art.

The control device 100 may further comprise a plurality of horizontally disposed rectangular light pipes or light bars 215. Each light bar 215 may be positioned adjacent a respective backlight light source 304. Light bars 215 may comprise a length that spans substantially the width of the allowable indicia area 109 for dispersing light from light source 304 and substantially evenly backlighting the indicia 104 on button 102. According to another embodiment, light bar 215 may span the width of the button 104 to backlight substantially the entire button 102. According to an embodiment, the light bars 215 may be interconnected into a single tree structure.

The front cover portion 204 comprises a front wall 208 with a substantially flat front surface. The front wall 208 may comprise a plurality of openings 209 extending traversely therethrough aligned with and adapted to provide access to the tactile switches 303. A switch actuator 210 may extend within each openings 209, for example in the form of a lever adapted to be pressed to actuate a corresponding switch 303. The back of each button 102 may comprise a projection 402 (FIG. 4) adapted to depress the respective switch actuator 210, which in turn actuates the respective switch 303 located on the PCB 301. Although according to an embodiment, the button 102 may comprise a switch actuator such that the button 102 can directly actuate the tactile switch 303. The front wall 208 further comprises a longitudinal recessed notch 213 as well as a plurality of tab receivers 214 recessed in its two opposite side edges 216. For example, to accommodate six buttons 102, six tab receivers 214 may be provided on each side edge 216. Each button 102 in turn may comprise a pair of tabs 217 rearwardly extending from its opposite side edges adapted to attach to respective tab receivers 214, for example via snap fit connection. In addition, front wall 208 may further comprise a plurality of orifices 218 extending therethrough, and each button 102 may comprise a pair of arms 403 extending from its rear surface and adapted to engage the orifices 218 for further alignment and engagement of the buttons 102 with the front cover portion 204.

Front wall 208 may further comprise rectangular horizontal openings 219 extending traversely therethrough, each sized to receive of a respective light bar 215 therein. Openings 219 may further comprise a plurality of notches 404 adapted to receive corresponding feet 314 extending from each light bar 215 to align and retain the light bar 215 within openings 219. Front wall 208 may further comprise indicator light openings 221 for directing light from indicator light sources 305 to illuminate therethrough in isolation from openings 219 as further discussed below.

Referring to FIGS. 2 and 3, the control device 100 defines a plurality of button zones 220a-f adapted to receive one or a plurality of rows of possible button heights. Each button zone 220a-f may be configured to receive a single height button 102. For example, the control device 100 is shown containing six button zones 220a-f adapted to receive six single height buttons, but it may comprise any other number of button zones and buttons. According to an embodiment, each button zone 220a-f comprises a pair of button tab receivers 214, one or more button alignment orifices 218, a tactile switch 303 and a respective switch actuator 210, one or more touch sensors as discussed above, a light bar 215, a corresponding a light bar opening 209 and a corresponding light source 304, and an indicator light opening 221 and corresponding indicator light source 305. A single height button 102 comprises a height substantially equal to the height of a single button zone 220a-f such that it may be attached to the front cover portion 204 at any one of the button zones 220a-f. For example, the single height button 102 may be attached to the front cover portion 204 at zone 220a by being snapped onto the front cover portion 204 where tabs 217 and alignment arms 403 of button 102 engage tab receivers 214 and alignment orifices 218, respectively, on the front cover portion 204, and projection 402 is aligned with respective switch 303 at zone 220a. Additionally, as further discussed below, each light bar 215 is adapted to be disposed in substantially the center of the respective button zone 220a-f and comprises a size and shape that spans substantially the width of the front wall 208 of the front cover portion 204 such that the indicia 104 on the corresponded button 102 is backlighted evenly. The alignment orifices 218 and the tactile switch 303 and switch actuator 210 of each zone 220a-f may be disposed below the respective light bar 215, while the light sources 304 and 305 may be aligned with and disposed on two opposite ends of the light bar 215. However, other arrangements are contemplated by the present embodiments.

Referring to FIG. 11, the control device 100 of the present embodiments may interchangeably receive various multi-zone height buttons to provide a vast number of possible configurations, as required by an application, some of which are shown in FIG. 11. Two or more button zones 220a-f may be combined to receive a multi-zone height button, such as a two-zone height button 1102, a three-zone height button 1103, a four-zone height button 1104, a five-zone height button 1105, or a six-zone height button 1106, comprising heights that span corresponding number of button zones 220a-f. These buttons 1102-1106 may comprise a single projection 402 to depress one of the tactile switches 303, or a plurality of projections 402 to depress a plurality of switches 303, for example for a side-to-side or up-and-down rocker type operation. Other button assembly configurations are also contemplated by the present embodiments. Additionally, using a plurality of tactile switches in each button zone row, a plurality of touch sensing buttons, or any combinations thereof, the various single or multi-zone button heights may be configured to operate as a single press button, a left/right rocker, or an up/down rocker. According to an embodiment, the various button configurations beneficially share the same circuit board layout shown in FIG. 3 by utilizing one or more of the tactile switches 303, and/or touch sensing buttons. In addition, for buttons that span two or more button zones 220a-f, one or more lines of indicia 104 may be included and individually backlit. Each line of indicia 104 may be aligned with backlighting of any one of the button zone 220a-f. For example, a three-zone height button 1103 may comprise three lines of indicia 104, each individually backlit by a respective zone. As another example, a six-zone height button 1106 may also comprise three lines of individually backlit indicia 104, while backlighting of zones containing no indicia 104 may be disabled.

Control device 100 can be configured in the field, such as by an installation technician, in order to accommodate many site-specific requirements. Field configuration can include selection and installation of an appropriate button configuration based on the type of load, the available settings for the load, etc. Advantageously, such field configurability allows an installation technician to adapt the electrical device to changing field requirements (or design specifications). Beneficially, the buttons are field replaceable without removing the device from the wall. After securing the buttons 102 on the control device 100, the installer may program the button configuration through tapping all of the placed buttons. The configured buttons can then be assigned to a particular load or function.

According to the present embodiments, the configuration of control device 100, including the front cover portion 204, light bars 215, and buttons 102, provides even backlighting to each button 102 (and/or indicia 104 thereon) using a single side LED 304. In addition, the configuration according to the present embodiments prevents light bleed between button zones, and within the button itself 102, for example between the backlight area provided by the first LED 304 and the indication area provided by the second LED 305. Referring to FIGS. 5A through 5C, FIG. 5A shows a front view of button 102, FIG. 5B shows a rear perspective view of button 102, and FIG. 5C shows a cross sectional view of button 102 across cross section line 5c in FIG. 5B according to one embodiment. Button 102 may comprise a front wall 501 comprising the front surface 103 and a rear surface 503 extending between a first side 504 and a second side 505. A pair of side walls 502 may transversely or laterally extend from the sides 504 and 505 of the front wall 501 away from the rear surface 503. Each side wall 502 of button 102 may comprise the pair of tabs 217 extending from the side wall 502 to engage the tab receivers 214 on the front cover portion 204. In addition, when attached to the front cover portion 204, the side walls 502 are adapted to partially reside within the longitudinal recessed notches 213 in the side edges 216 of the front cover portion 204. The button 102 may further comprise the tactile switch projection 402 and the alignment pair of arms 403 transversely extending from the rear surface 503 adjacent to the bottom edge of the front wall 501 as discussed above.

If the button 102 contains a separate light indicator 105, the button 102 may further comprise a divider 508a made of opaque material recessed in the rear surface 503 and below the front surface 103 of the button 102 such that the divider 508a is not perceived from the front surface 103 of the button 102. The divider 508a at least partially prevents light bleed between backlight area 109 and light indicator area 105 on button 102. According to an embodiment, divider 508a may be substantially flush with the rear surface 503 of the button 102. According to another embodiment, the divider 508a may rearwardly extends from the rear surface 503. The divider 508a may comprise opaque material, such as black, grey, or similarly dark color plastic or the like, that impedes or hinders light transmission through the divider 508a in the front wall 501 of the button 102.

Another embodiment of the button 102 is shown in FIGS. 5D and 5E. According to an embodiment, the front wall 501 may comprise a thickness that is thicker proximate the button's first side 504 and thinner proximate to the button's second side 505. For example, the front wall 501 may comprise a rectangularly shaped depression 506a longitudinally recessed in the rear surface 503 of the button 102. Depression 506a may be arranged off center proximate to the second side 505 of button 102. The depression 506a may extend from a first end 513 proximate to the center of button 104 to a second end 514 proximate to the button's second end 505. The depression 506a may comprise a first portion 511 proximate to its first end 513 and a second portion 512 proximate to its second end 514, where the first portion 511 is shorter than the second portion 512. The second portion 512 gradually tapers down from a first end 513 to a second end 514 such that the front wall 501 is thicker at the first end 513 and gradually gets thinner at the depression 506a proximate the second end 514. The first portion 511, on the other hand, has a steeper taper than the taper in the second portion 512. Accordingly, the front wall 501 of the button 102 comprises a thicker thickness proximate to its first side 504 that allows for less light transmission through the button 102, and a gradually decreasing thickness towards its second side 505 that allows for gradually greater light transmission through the button 102 as light approaches the second side 505.

FIGS. 5D and 5E also illustrate another embodiment of a divider 508b, which can comprise a fin extension 509 made of the same material as the divider 508a and adapted to rearwardly extend from the rear surface 503 to hinder light transmission between backlight area 109 and light indicator area 105 on button 102. Divider 508a may be disposed between the depression 506a and the second side 505.

According to another embodiment, the front wall 501 of the button may be gradually reduced in thickness from the first side 504 to the second side 505. Referring to FIGS. 5F and 5G, there is shown yet another embodiment of button 102 with depression 506b. Depression 506b may comprise a rectangular shape that substantially spans the size of the backlight area 109 of button 102. Depression 506b may extend from a first end 515 proximate to the first end 504 of button 102, to a second end 516 proximate to the second end 505 of button 102, adjacent the light indicator area 105. Depression 506b may gradually taper down from the first end 515 with a thicker thickness that allows for less light transmission to the second end 516 with a thinner thickness for gradually greater light transmission through the button 102 as light approaches the second side 505. According to an embodiment, a measuring tool may be used to measure light emission coming from the front surface 603 (FIG. 6A) of the light bar 215 from its first end 601 to its second end 602 to determine light emission fluctuations. The measured light may be plotted on a first curve representing the fluctuation in light emission coming from the front surface 603. The first curve may be inverted to a second curve to determine the compensation needed to make light emission at the front surface 603 substantially even. According to an embodiment, that second inverted curve may be used to determine a thickness gradient of the depression 506b that will compensate the measured light emission fluctuations.

Referring next to FIGS. 6A through 6C, where FIG. 6A shows a top perspective view of the light bar 215, FIG. 6B shows a side view of the light bar 215, and FIG. 6C shows a rear perspective view of the light bar 215. Light bar 215 may comprise a substantially rectangular shape comprising a front surface 603 and a rear surface 604 longitudinally extending between a first side 601 and a second side 602. Although light bar 215 may comprise other shapes, such as a cylindrical rod. According to the present embodiments, light bar 215 is configured to reflect, distribute, and diffuse light from a respective light source 304 to an individual button 102 to uniformly backlight the button 102 and/or indicia 104 thereon. Light bars 215 may be fabricated from transparent material to transmit light from first side 601 to second side 602, such as optical fiber or plastic material, including but not limited to an acrylic such as PMMA, a polymer such as polycarbonate or Zeonex®, a silicone, a thermoplastic, or the like. Each light source 304 may comprise a side firing LED that extends out of the front surface of the PCB 301 and directs light from its side into the first side 601 of a respective light bar 215 as shown in FIG. 10. Although a front firing LED may also be used, such as LED 305. First side 601 may comprise a taper that tapers inwardly from the front surface 603 to the rear surface 604 to capture light from the light source 304, although according to another embodiment first side 601 may be flat. The second side 602 of the light bar 215 comprises a taper that tapers outwardly from the front surface 603 to the rear surface 604 to increase light intensity proximate to the second side 602. In particular, the taper at the second side 602 of the light bar 215 allows light that has been reflected within the light bar 215 to exit the light bar 215 through the second side 602 to increase light intensity at the second side 602 of the light bar 215. The taper at the second side 602 forms an acute angle 605 between the second side 602 and the rear surface of the light bar 215. According to an embodiment, the angle 605 comprises the incident angle of the material used for the light bar 215. For example, for acrylic material, the angle 605 corresponds to incident angle of about 42 degrees. Although according to another embodiment, angle 614 may range between about 20 degrees to about 90 degrees. Other or additional reflective optic elements may be included on the surfaces of the light bar 215, such as on the front surface 603 and/or the second side 602 to increase light intensity at the second side 602 and/or to enable substantially even light distribution across the width of the button 102. For example, additional angled cutouts may be introduced at the front surface 603 of the light bar 215.

The rear surface 604 of the light bar 215 may further comprise a diffusion gradient adapted to substantially evenly distribute light across the front surface 603 of the light bar by gradually increasing diffusion of the light from the first side 601 to the second side 602. Referring to FIGS. 7A and 7B there is illustrated an embodiment of a diffusion gradient 710. Diffusion gradient 710 may comprise a plurality of areas of reflection arranged on the rear surface 604 of the light bar 215. The diffusion gradient 710 may be formed by being silk screened on the rear surface 604 of the light bar 215 using white ink diffuse or scatter light in many different directions. Although other reflective ink or material may be used, and the diffusion gradient may be formed via other type of printing, or by using a separate layer or sticker disposed against the rear surface 604 of the light bar 215. According to an embodiment, diffusion gradient 710 may comprise a plurality of white lines or rectangles of different sizes (i.e., thickness) and frequency (i.e., closeness) arranged to form a pattern. Although according to other embodiments, areas of reflection may comprise other shapes, such as circles, triangles, squares, irregular shapes, or the diffusion gradient 710 may comprise a gradual blend of two or more colors, such as from white to black, white to grey, or the like.

According to an embodiment, diffusion gradient 710 may comprise a pattern 702 disposed between the first side 601 and the second side 602 of the light bar 215. Diffusion gradient pattern 702 comprises thinner and more spaced apart white lines 702a-b that create smaller areas of reflection proximate to the first side 601 of the light bar 215 to reflect less light towards and out of the front surface 603, and a gradually thicker and closer larger white lines 702a-b that create larger areas of reflection approaching the second side 602 of the light bar 215 to reflects more light towards and out of the front surface 603. The areas of reflection 702a-b and the clear areas in between without reflective material interact and alternate to pull light through from the first end 601 to the second end 602 and push the light out of the front surface 603 of the light bar 215, and accordingly assist to substantially evenly distributing the light emitted through the front surface 603. According to an embodiment, as shown, the pattern 702 may comprise first thinner areas of reflection or white lines 702a that alternate between a second thicker areas of reflection or white lines 702b. Thinner lines 702a and thicker lines 702b alternate between the first end 601 and the second end 602 and gradually get thicker and less spaced apart. According to a further embodiment, to help increase light intensity and evenness at the sides 601 and 602 of the light bar 215, the diffusion gradient pattern 702 may be disposed approximately at the center of the light bar 215 between a first area of reflection 701 adjacent the first side 601 and a second area of reflection 703 adjacent the second side 602 comprising different patterns than pattern 702. The first area of reflection 701 may comprise a large rectangular area that captures light from the backlight LED 304 to increase overall intensity and evenness of light through the light bar 215. As light travels through the light bar 215, a percent of it contacts the reflective surface of the gradient pattern 702 and is reflected up toward the front surface 603 as it travels. As light continues to travel from first side 601 to second side 602, less and less light becomes available. Accordingly, the diffusion gradient pattern 702 changes from thinner and less frequent areas of reflection proximate the first side 601 to thicker and more frequent areas of reflection proximate the second side 602 to reflect more light. As light approaches the angled second side 602 at the end of the light bar 215, the angled second side 602 causes a lot of light to reflect up and back through the light bar 215, which may cause a “hot” spot at the second side 602. Accordingly, the second area of reflection 703, positioned beneath and across the angled second side 602, changes to thinner and less frequent areas of reflection to even out the brightness at the second side 602. The shown pattern of the diffusion gradient 710 is established to increase brightness and evenly guide light between the first side 601 and the second side 602 and out through the front surface 603 of the light bar 215.

Referring to FIGS. 8A and 8B, there is shown another embodiment of a diffusion gradient 810. Diffusion gradient 810 may comprise a plurality of white dots that gradually change from being farther disposed from each other proximate to the first side 601 to being closer disposed to each other proximate to the second side 602. In addition, or alternatively, the white dots may increase in size from smaller dots proximate to the first side 601 to larger dots proximate to the second side 602. Essentially, the diffusion gradient 810 creates a smaller white containing areas proximate to the first side 601 of the light bar 215 that reflects less light towards and out of the front surface 603 and a gradually larger white containing area approaching the second side 602 of the light bar 215 that reflects more light towards and out of the front surface 603.

According to another embodiment, the diffusion gradient may be infused into or be part of the light bar 215. For example, as shown in FIG. 9, the light bar 215 may comprise a plastic material that gradually changes in color, for example from clear to white, such that a diffusion gradient 910 is formed by the color of the light bar 215. In FIG. 9, the light bar 215 closer to the first side 601 is clear (represented in black color), and gradually changes from clear to white approaching the second side 602.

Referring next to FIG. 4 as well a FIG. 10, showing a partial cross sectional view of the load control device 100 along cross section line 9 in FIG. 1. As shown in FIG. 4, each light bar cavity 219 in the front cover portion 204 is surrounded by a pair of lateral walls 407 extending between a first side wall 405 and a second side wall 406. When the button 102 is attached to the front cover portion 204, openings 219 are substantially isolated and masked from each other preventing the backlight of one zone from bleeding into adjacent zones. In particular, each cavity 219 is surrounded by the first and second side walls 405 and 406 and the lateral walls 407 of the front cover portion 204 as well as by the front wall 501 and the side walls 502 of the button 102 (as the side walls 502 of the buttons 102 partially reside within the longitudinal recessed notches 213 and overlap the side edges 216 of the front cover portion 204). According to an embodiment, the front cover portion 204 may comprise an opaque material, such as black, grey, or similarly dark colored plastic or the like, that impedes light transmission through the front wall 208 to prevent light bleeding from one set of light bar 215 and corresponding light source 304 to another set. The interior surface of each cavity 219, including the interior surface of laterals walls 407 and side walls 405 and 406, may on the other hand comprise a reflective surface or material 410. The reflective surface 410 may be formed by being silk screened using white ink, other reflective ink or material, other type of printing, by using a separate layer or sticker, or the like. Reflective surface 410 assists in reflecting light, increase its intensity, and disperse it within the cavity 219.

The rear surface 604 of the light bar 215 is positioned against the front surface of the PCB 301 within the cavity 219 in the front cover portion 204 such that its first side 601 faces the side firing LED 304. The first side wall 405 of cavity 219 may comprise a hood 408 that encloses the side firing LED 304 between the PCB 301 and the hood 408 such that light from the LED 304 is directed into the first side 601 of the light bar 215. The light from the LED 304 enters the first side 601 of the light bar 215 and exits through its front surface 603 and through the button 102 or the indicia 104 at the indicia area 109 thereon. Since only a single LED 304 is used illuminating at the first side 504 of the button 102, typically this will create uneven light distribution, creating a hot or brighter zone proximate to where the LED 304 is located at the first side 504 of the button 102 and a dimmer zone distal to the LED 304 at the second side 505 of the button 102. According to the present embodiments, reflective surface 410, the angle 605 of the second side 602 of the light bar 215, the diffusion gradient 710 on the rear surface 604 of the light bar 215, and/or the depression 506a in the rear surface 503 of the button 102 (FIG. 5D-5G), cooperate to enhance light intensity and promote a substantially even and continuous light distribution between the first side 504 and the second side 505 of the button 102, and thereby throughout the allowable indicia area 109, using a single LED 304. These features help to increase overall brightness, and even out brightness between the hot zones proximate to the sides 504 and/or 505 of the button 102 with respect to the center of the button 102. In particular, the taper at the second side 602 of the light bar 215 allows more light to be pulled and absorbed from the LED 304 and reflected from the tapered second side 602 of the light bar 215. The diffusion gradient 710 reflect less light from the first side 601 of the light bar 215 and reflect more light from the second side 602 to evenly distribute light between the first side 601 and the second side 602 of the light bar 215 as well as assisting in reducing hot spots. The reflective surface 410 reflects light and pushes it out of the cavity towards the button 102. Furthermore, if a depression 506a is included (FIG. 5D-5G), less light is transmitted through the thicker front wall 501 proximate the button's first side 504 and more light is transmitted through the thinner front wall 501 proximate to the button's second side 505.

According to an embodiment, to provide a separately controlled light indicator 105 within a single button 102, each light bar cavity 219 may be further divided using a separation wall 409 into a first enclosure 1011 and a second enclosure 1012. Separation wall 409 may be recessed into the PCB 301 to provide additional masking to prevent light bleed between the first and second enclosures 1011 and 1012. When the button 102 is attached to the front cover portion 204, the divider 508a extending from the rear surface 503 of the button 102 is disposed adjacent to the separation wall 409. According to an embodiment, the divider 508a may include a fin 509 (FIGS. 5D-5E) that may partially overlap with the separation wall 409. Accordingly, by mutual interaction, the first and second side walls 405 and 406, the lateral walls 407, and the separation wall 409 of the front cover portion 204 together with and the front wall 501, the side walls 502, and the divider 508a of the button 102 create substantially isolated first and second enclosures 1011 and 1012. The second light source 305 is disposed on the PCB 301 within the second enclosure 1012 to direct light towards the light indicator 105 on button 102. Since first and second enclosures 1011 and 1012 are substantially isolated, light bleed is substantially prevented, and beneficially backlighting provided by light source 304 may be independently controlled from light source 305, such as for example to be illuminated at different color, one being on and another off, and/or at different light intensities.

### INDUSTRIAL APPLICABILITY

The disclosed embodiments provide an apparatus, system, and method for backlighting the buttons of a load control device in a cost effective and efficient manner while achieving substantially even light distribution and enhanced backlighting effects. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Although the features and elements of aspects of the embodiments are described being in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

Additionally, the various methods described above are not meant to limit the aspects of the embodiments, or to suggest that the aspects of the embodiments should be implemented following the described methods. The purpose of the described methods is to facilitate the understanding of one or more aspects of the embodiments and to provide the reader with one or many possible implementations of the processed discussed herein. The steps performed during the described methods are not intended to completely describe the entire process but only to illustrate some of the aspects discussed above. It should be understood by one of ordinary skill in the art that the steps may be performed in a different order and that some steps may be eliminated or substituted.

All United States patents and applications, foreign patents, and publications discussed above are hereby incorporated herein by reference in their entireties.

### ALTERNATE EMBODIMENTS

Alternate embodiments may be devised without departing from the spirit or the scope of the different aspects of the embodiments.

What is claimed is:

1. A control device for controlling an associated electrical load comprising:
a front housing portion comprising a switch, a first LED, and a longitudinal light bar having a front surface and a rear surface extending between a first side and a second side, wherein the first LED is positioned to direct light into the first side of the light bar;
a controller electrically connected to the switch to send a control signal to the associated electrical load in response to an actuation of the switch;
a button comprising a front surface and a rear surface extending between a first side and a second side, wherein the button attaches to the front housing portion and is adapted to actuate the switch, wherein the button comprises an opaque material and a first backlit area formed therethrough comprising translucent material, wherein the first backlit area is positioned over the front surface of the light bar and is backlit by the first LED;
wherein the rear surface of the light bar comprises a diffusion gradient comprising a plurality of areas of reflection to facilitate light distribution between the first side of the light bar and the second side of the light bar.

2. The control device of claim 1, wherein the diffusion gradient comprises a plurality of areas of reflection that gradually increase in size and/or frequency from the first side of the light bar to the second side of the light bar.

3. The control device of claim 1, wherein the diffusion gradient comprises a pattern of a plurality of areas of reflection that gradually change from thinner and less frequent areas of reflection proximate the first side of the light bar to thicker and more frequent areas of reflection proximate the second side of the light bar.

4. The control device of claim 3, wherein the gradient further comprises a first area of reflection disposed between the first side of the light bar and the pattern, wherein the first area of reflection is larger than any one of the plurality of areas of reflection in the pattern to capture light from the first LED and increase light intensity.

5. The control device of claim 3, wherein the second side of the light bar is disposed at an acute angle with respect to the rear surface of the light bar to capture light and increase light intensity proximate to the second side of the light bar, wherein the diffusion gradient further comprises a second area of reflection disposed beneath the angled second side of the light bar that changes to thinner and less frequent areas of reflection in comparison to the pattern proximate the second side of the light bar.

6. The control device of claim 1, wherein the diffusion gradient comprises a pattern having a first thinner areas of reflection that alternate between a second thicker areas of reflection, wherein the first thinner areas of reflection and the second thicker areas of reflection gradually get thicker and less spaced apart from the first side of the light bar to the second side of the light bar.

7. The control device of claim 1, wherein the diffusion gradient comprises the light bar gradually changing in color from being a first color proximate to the first side of the light bar that diffuses less light, to being a second color proximate to the second side of the light bar that diffuses more light.

8. The control device of claim 1, wherein the second side of the light bar is disposed at an acute angle with respect to the rear surface of the light bar to capture light and increase light intensity proximate to the second side of the light bar.

9. The control device of claim 8, wherein the angle comprises an incident angle of a material of the light bar.

10. The control device of claim 1, wherein the first side of the light bar comprises a taper that tapers inwardly from the front surface of the light bar to the rear surface of the light bar to capture light from the first LED.

11. The control device of claim 1, wherein the front housing portion comprises a cavity formed by lateral periphery walls that surround the light bar and the first LED.

12. The control device of claim 11, wherein the front housing portion comprises opaque material to hinder light transmission through the lateral periphery walls, wherein an inner surface of the lateral periphery walls comprise light reflective material.

13. The control device of claim 11, wherein at least one of the lateral periphery walls comprises a hood that encloses the first LED between the at least one of the lateral periphery walls and the first side of the light bar such that light from the first LED is directed to the first side of the light bar.

14. The control device of claim 11, wherein the button comprises a second backlit area formed therethrough comprising translucent material, wherein the front housing portion further comprises a second LED positioned within the cavity, wherein the cavity comprises a separation wall that separates the first LED and the light bar from the second LED, wherein the second backlit area is positioned over and is backlit by the second LED.

15. The control device of claim 14, wherein the button comprises a divider made of an opaque material recessed in the rear surface and below the front surface of the button such that the divider is not perceived from the front surface, wherein the divider is positioned adjacent the separation wall to hinder light transmission between the first backlit area and the second backlit area.

16. The control device of claim 15, wherein the divider comprises a fin rearwardly extending from the rear surface of the button, wherein the fin partially overlaps and disposed adjacent to the separation wall to hinder light transmission between the first LED and the second LED.

17. The control device of claim 1, wherein the button comprises a depression recessed in the rear surface of the button, wherein the first backlit area is at least partially formed at the depression, wherein the button at the depression comprises a thickness that is thicker proximate the first side of the button to allow less light transmission through the first backlit area and gradually thinner proximate to the second side of the button to allow for gradually greater light transmission through the first backlit area.

18. A control device for controlling an associated electrical load comprising:
a front housing portion comprising a switch, a first LED, a second LED, and a longitudinal light bar having a front surface and a rear surface extending between a first side and a second side, wherein the first LED is positioned to direct light into the first side of the light bar;
a controller electrically connected to the switch to send a control signal to the associated electrical load in response to an actuation of the switch;
a button comprising a front surface and a rear surface extending between a first side and a second side, wherein the button attaches to the front housing portion and is adapted to actuate the switch, wherein the button comprises an opaque material and first and second backlit areas formed therethrough comprising translucent material, wherein the first backlit area is positioned over the front surface of the light bar and is backlit by the first LED, and wherein the second backlit area is positioned over and backlit by the second LED;
wherein the front housing portion comprises a cavity formed by lateral periphery walls that surround the light bar, the first LED, and the second LED, wherein the cavity comprises a separation wall that separates the first LED and the light bar from the second LED, and wherein the button comprises a divider made of an opaque material recessed in the rear surface and below the front surface of the button such that the divider is not perceived from the front surface, wherein the divider is positioned adjacent the separation wall to hinder light transmission between the first backlit area and the second backlit area.

19. The control device of claim 18, wherein the front housing portion comprises opaque material to hinder light transmission through the lateral periphery walls, wherein an inner surface of the lateral periphery walls comprise light reflective material.

20. The control device of claim 18, wherein the divider comprises a fin rearwardly extending from the rear surface of the button, wherein the fin partially overlaps and disposed adjacent to the separation wall to hinder light transmission between the first LED and the second LED.
